(19) United States
(12) Patent Application Publication
(10) Pub. No.: US 2022/0405474 A1
(43) Pub. Date: Dec. 22, 2022

(54) METHOD, COMPUTING DEVICE AND COMPUTER-READABLE MEDIUM FOR CLASSIFICATION OF ENCRYPTED DATA USING NEURAL NETWORK

(71) Applicants: Kongju National University Industry-University Cooperation Foundation, Gongju-si (KR); Daegu Gyeongbuk Institute of Science and Technology, Daegu (KR)

(72) Inventors: Changho Seo, Daejeon (KR); Inkyu Moon, Daegu (KR); Hyunil Kim, Daejeon (KR); Ezat Ahmadzadeh, Daegu (KR)

(21) Appl. No.: 17/461,889

(22) Filed: Aug. 30, 2021

(30) Foreign Application Priority Data
Jun. 21, 2021 (KR) 10-2021-0080909

(51) Int. Cl. G06F 40/284; G06N 3/08; G06N 3/04

(52) U.S. Cl. CPC G06F 40/284; G06N 3/08; G06N 3/0454; G06N 3/0445

(57) ABSTRACT

The present invention relates to a method, a computing device and a computer-readable medium for classification of encrypted data using neural network, and more particularly, to a method, a computing device and a computer-readable medium for classification of encrypted data using neural network to derive an embedding vector by embedding text data encrypted through an encryption technique, input the embedding vector to a feature extraction module to which a plurality of neural network models are connected, and enable the encrypted text data to be labeled without a separate decryption process by labeling the encrypted text data with a specific classification item based on a learning vector including a feature value derived from the feature extraction module.

### BACKGROUND OF THE INVENTION

### 1. Field of the Invention

The present invention relates to a method, a computing device and a computer-readable medium for classification of encrypted data using neural network, and more particularly, to a method, a computing device and a computer-readable medium for classification of encrypted data using neural network to derive an embedding vector by embedding text data encrypted through an encryption technique, input the embedding vector to a feature extraction module to which a plurality of neural network models are connected, and enable the encrypted text data to be labeled without a separate decryption process by labeling the encrypted text data with a specific classification item based on a learning vector including a feature value derived from the feature extraction module.

### 2. Description of the Related Art

Recently, as sensors are advanced and IoT technology is developed, numerous data are created every hour, and big data constructed according to the numerous data is utilized to derive meaningful information suitable for various purposes. In particular, as various wearable devices such as smart watches are commercialized, data analysis for disease prediction is performed through the process of collecting biometric information or the like about users or patients using the wearable devices and classifying the collected biometric information.

Meanwhile, the IoT devices such as wearable devices may store the collected data in the IoT devices themselves. However, in general, the collected data is transmitted to cloud storage so that the collected data is stored in a cloud server. Accordingly, as the collected data is stored in the cloud server, the data may be easily accessed or managed.

However, when sensitive personal information such as the user's biometric information as described above is stored in the cloud server as it is without processing, damage may occur due to leakage of the personal information. Accordingly, in the related art, the collected personal information is encrypted and stored in the cloud server.

Meanwhile, although the above-encrypted data may satisfy the confidentiality of the data, there are technical limitations in processing and analyzing the data. Particularly, although neural network-based artificial intelligence is used for a data classification task of labeling data with a specific classification item among a plurality of classification items, the task generally corresponds to a level that classifies unencrypted plaintext data.

Accordingly, as a conventional method for classifying encrypted data using artificial intelligence, a prior non-patent literature document 1 has proposed a data classification technique of classifying encrypted image data by using convolution neural networks (CNN) corresponding to a neural network model. However, because the prior non-patent literature document 1 is limited to the encrypted image data, and the image data is different from text data having sequential data characteristics, it is difficult to apply the technique to the text data. In addition, because the classification item (class) corresponds to a binary class that is limited by two items, it is difficult to apply the prior non-patent literature document 1 to a general case with three or more classification items.

Meanwhile, in a prior non-patent literature document 2, it has been studied on a method for classifying encrypted text data through artificial intelligence by using homomorphic encryption technology having the same characteristics between the result obtained by calculating and encrypting plaintext and the result obtained by calculating an encrypted plaintext. However, in the prior non-patent literature document 2, the classification item is also limited as being classified into a specific class among binary classes. In addition, because the data encrypted with the homomorphic encryption technology used in the prior non-patent literature document 2 has a large size compared to the data encrypted by the general encryption technology, the encrypted data may occupy a lot of storage space and a large amount of computation may be required for computing the data encrypted by the homomorphic encryption technology. Accordingly, currently, homomorphic encryption technology is rarely used, and symmetric key encryption technology is generally used.

Thus, in the above-described technology for classifying encrypted data based on artificial intelligence, it is required to develop a new method that can classify text data encrypted through the general encryption technology and universally classify three or more classes.

[Prior Non-Patent Literature Document 1]
V. M. Lidkea et al., “Convolutional neural network framework for encrypted image classification in cloud-based ITS,” IEEE Open Journal of Intelligent Transportation Systems, pp. 35-50, 2020.

[Prior Non-Patent Literature Document 2]
R. Podschwadt and D. Takabi, “Classification of encrypted word embeddings using recurrent neural networks,” in Private NLP, WSDM, pp. 27-31, 2020.

### SUMMARY OF THE INVENTION

The present invention relates to a method, a computing device, and a computer-readable medium for classification of encrypted data using neural network, and more particularly, provides a method, a computing device and a computer-readable medium for classification of encrypted data using a neural network to derive an embedding vector by embedding text data encrypted through an encryption technique, input the embedding vector to a feature extraction module to which a plurality of neural network models are connected, and enable the encrypted text data to be labeled without a separate decryption process by labeling the encrypted text data with a specific classification item based on a learning vector including a feature value derived from the feature extraction module.

In order to solve the above technical problem, one embodiment of the present invention provides a method performed on a computing device including at least one processor and at least one memory to classify encrypted data based on neural network, and the method includes: an embedding step of digitizing encrypted text data to generate an embedding vector corresponding to the encrypted text data and having a vector form; a feature extraction step of deriving a learning vector including a plurality of feature values corresponding to the embedding vector, by a feature extraction module including a plurality of trained neural network models; and a classification step, by a classification module including a plurality of fully connected layers, of receiving the learning vector as input to label the encrypted text data with a specific classification item among a plurality of classification items into which the encrypted text data is classified.

According to one embodiment of the present invention, the encrypted text data may correspond to text data encrypted using a symmetric key encryption.

According to one embodiment of the present invention, the embedding step may include: a token generation step of generating a plurality of tokens in word units based on the encrypted text data; a data processing step of processing the encrypted text data by removing special characters and extra spaces contained in the encrypted text data; and an encoding step of generating an embedding vector for the processed encrypted text data by using the tokens;

According to one embodiment of the present invention, the feature extraction module may include a first neural network model, a second neural network model, and a third neural network model, and the feature extraction step may include: first feature information deriving step of deriving first feature information by inputting the embedding vector to the first neural network model; second feature information deriving step of deriving second feature information by inputting the first feature information to the second neural network model; third feature information deriving step of deriving third feature information by inputting the second feature information to the third neural network model; and a learning vector deriving step of deriving a learning vector based on the third feature information.

According to one embodiment of the present invention, in the feature extraction step, the first feature information deriving step, the second feature information deriving step and the third feature information deriving step may be repeated N times (N is a natural number of 2 or more) until the learning vector deriving step is performed, and each of the neural network models repeated M times (M is a natural number of N or less) may derive the feature information by using hidden state information derived after repeated M−1 times.

According to one embodiment of the present invention, the feature extraction module may include a first neural network model, a second neural network model, and a third neural network model, in which the first neural network model may correspond to a bidirectional LSTM (BLSTM) neural network model, the second neural network model may correspond to a gated recurrent unit (GRU) neural network model, and the third neural network model may correspond to a long-short term memory (LSTM) neural network model.

According to one embodiment of the present invention, the classification step may include: inputting the learning vector to the fully connected layers to derive an intermediate vector having a size corresponding to the number of a plurality of classification items into which the encrypted text data is classified; and labeling the encrypted text data as a specific classification item among the classification items by applying a Softmax function to values included in the intermediate vector.

In order to solve the above technical problem, one embodiment of the present invention provides a computing device including at least one processor and at least one memory to perform the method for classifying encrypted data based on neural network, and the computing device performs: an embedding step of digitizing encrypted text data to generate an embedding vector corresponding to the encrypted text data and having a vector form; a feature extraction step of deriving a learning vector including a plurality of feature values corresponding to the embedding vector, by a feature extraction module including a plurality of trained neural network models; and a classification step, by a classification module including a plurality of fully connected layers, of receiving the learning vector as input to label the encrypted text data with a specific classification item among a plurality of classification items into which the encrypted text data is classified.

In order to solve the above problem, one embodiment of the present invention provides a computer program stored on a computer-readable medium and including a plurality of instructions executed by at least one processor, and the computer program includes: an embedding step of digitizing encrypted text data to generate an embedding vector corresponding to the encrypted text data and having a vector form; a feature extraction step of deriving a learning vector including a plurality of feature values corresponding to the embedding vector, by a feature extraction module including a plurality of trained neural network models; and a classification step, by a classification module including a plurality of fully connected layers, of receiving the learning vector as input to label the encrypted text data with a specific classification item among a plurality of classification items into which the encrypted text data is classified.

According to one embodiment of the present invention, data classification can be performed on the encrypted text data itself without decrypting the encrypted text data obtained by encrypting the plaintext text data.

According to one embodiment of the present invention, the data classification can be performed on symmetric key encryption currently used as an encryption scheme for data confidentiality in general, in addition to text data encrypted by homomorphic encryption.

According to one embodiment of the present invention, a hybrid neural network containing a plurality of neural network models is used, so that the accuracy of classifying the encrypted text data can be improved.

According to one embodiment of the present invention, data classification can be performed for at least 3 classes, in addition to data classification for binary class issues.

### BRIEF DESCRIPTION OF THE DRAWINGS

FIG. 1 schematically shows a process of classifying text data encrypted through a computing device according to one embodiment of the present invention.

FIG. 2 schematically shows internal components of the computing device according to one embodiment of the present invention.

FIG. 3 schematically shows a method of classifying encryption data performed in the computing device based on the neural network according to one embodiment of the present invention.

FIG. 4 schematically shows detailed steps of an embedding step according to one embodiment of the present invention.

FIG. 5 schematically shows internal components of a feature extraction module according to one embodiment of the present invention.

FIG. 6 schematically shows detailed steps of a feature extraction step according to one embodiment of the present invention.

FIG. 7A and FIG. 7B schematically show a first type of neural network according to one embodiment of the present invention.

FIG. 8 schematically shows a second type of neural network according to one embodiment of the present invention.

FIG. 9 schematically shows a third type of neural network according to one embodiment of the present invention.

FIG. 10 schematically shows detailed steps of a classification step according to one embodiment of the present invention.

FIG. 11 schematically shows a conceptual diagram of the method for classifying encrypted data based on the neural network according to one embodiment of the present invention.

FIG. 12A and FIG. 12B schematically show classification results according to the method of classifying encrypted data based on the neural network according to one embodiment of the present invention.

FIG. 13 schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited concerning the drawings.

The term “embodiment”, “example”, “aspect”, “exemplification”, or the like as used herein may not be construed in that an aspect or design set forth herein is preferable or advantageous to other aspects or designs. The terms ‘unit’, ‘component’, ‘module’, ‘system’, ‘interface’ and the like used in the following generally refer to a computer-related entity, may refer to, for example, hardware, software, or a combination of hardware and software.

In addition, the terms “include” and/or “comprise” specify the presence of the corresponding feature and/or element, but do not preclude the possibility of the presence or addition of one or more other features, elements or combinations thereof.

In addition, the terms including an ordinal number such as first and second may be used to describe various elements, however, the elements are not limited by the terms. The terms are used only to distinguish one element from another element. For example, the first element may be referred to as the second element without departing from the scope of the present invention, and similarly, the second element may also be referred to as the first element. The term “and/or” includes any one of a plurality of relevant listed items or a combination thereof.

In addition, in embodiments of the present invention, all terms used herein including technical or scientific terms, unless defined otherwise, have the same meaning as commonly understood by a person having ordinary skill in the art. Terms such as those defined in generally used dictionaries will be interpreted to have the meaning consistent with the meaning in the context of the related art, and will not be interpreted as an ideal or excessively formal meaning unless expressly defined in an embodiment of the present invention.

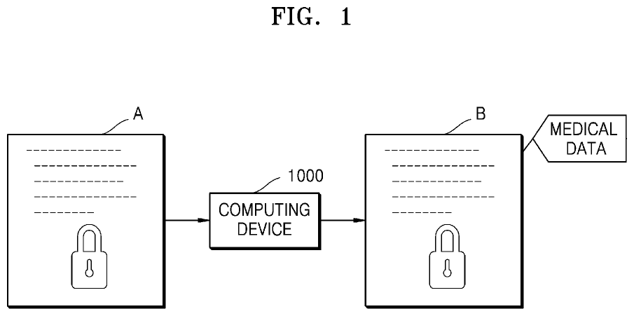

FIG. 1 schematically shows a process of classifying text data encrypted through a computing device 1000 according to one embodiment of the present invention.

As shown in FIG. 1, the computing device 1000 of the present invention may perform a classification task on encrypted text data by labeling B the encrypted text data A as a specific classification item among a plurality of classification items (classes).

The computing device 1000 may classify the encrypted text data itself into specific classification items by using at least one neural network as shown in FIG. 1, rather than performing the classification on the decrypted text data by decrypting the encrypted text data A.

Meanwhile, the encrypted text data A according to the present invention may correspond to text data encrypted using a symmetric key encryption.

Specifically, the computing device 1000 of the present invention may perform the classification task even on text data encrypted based on a symmetric key encryption that corresponds to a generally used encryption scheme. The text data encrypted based on the symmetric key encryption has characteristics that may fail to perform an analysis task such as data classification, since it is difficult to compute the encrypted text data itself without decryption. However, in the present invention, a plurality of neural network models are used, so that the data classification can be performed on the text data encrypted based on a symmetric key encryption.

Meanwhile, in another embodiment of the present invention, the classification task may also be performed on the encrypted text data by a homomorphic encryption scheme having characteristics in which the result value of computing and encrypting the unencrypted plaintext text data and the result value of computing the encrypted text data are the same.

Further, in another embodiment of the present invention, the classification task may also be performed on the encrypted text data by another encryption scheme that does not have the same characteristics as the above-mentioned homomorphic encryption, in addition to the text data encrypted based on the symmetric key encryption.

The present invention has described the data to be classified as text data. However, preferably, the data to be classified may correspond to sequential data, such as text data, in which objects included in the data have a sequence, and the sequential data may include time-series data such as voice data.

In addition, although ‘medical data’ is described as a classification item labeled in the encrypted text data shown in FIG. 1, the classification item in the present invention is not limited thereto, and may correspond to any one of a plurality of classification items for various subjects, such as a plurality of classification items for types of text data, such as ‘news article’, ‘diary’, ‘novel’, and ‘thesis’, and a plurality of classification items for genres of text data, such as ‘sci-fi’, ‘non-literature’, and ‘learning textbook’.

Hereinafter, the internal configuration of the computing device 1000 and the method for classifying encrypted text data performed through the computing device 1000 will be described in detail.

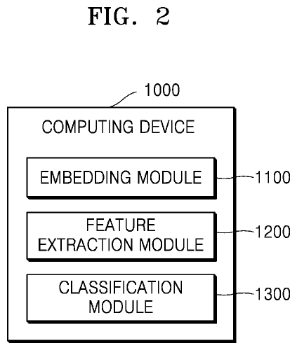

FIG. 2 schematically shows internal components of the computing device 1000 according to one embodiment of the present invention.

The computing device 1000 includes at least one processor and at least one memory, and the computing device 1000 may further include an embedding module 1100, a feature extraction module 1200 and a classification module 1300 to perform the method for classifying encrypted text data based on neural network according to the present invention.

Meanwhile, the internal configuration of the computing device 1000 shown in FIG. 2 corresponds to a drawing schematically shown in order to easily describe the present invention, and may additionally include various components that may be generally contained in the computing device 1000.

The embedding module 1100 derives the encrypted text data into a digitized form in order to process the encrypted text data through the computing device 1000, specifically, the feature extraction module 1200 including a neural network model and the classification module 1300. More specifically, the embedding module 1100 derives the encrypted text data in the form of a vector including at least one vector value. Accordingly, the embedding module 1100 expresses the encrypted text data into the vector form, and processes the vector, which is derived from the embedding module 1100, by the feature extraction module 1200 and the classification module 1300, so that the labeling may be performed on the encrypted text data.

The feature extraction module 1200 includes at least one neural network model, and uses the vector derived through the embedding module 1100 as an input for at least one neural network model, so that a learning vector including at least one feature value for the vector is derived. At least one feature value may correspond to an output value of a final neural network model of the at least one neural network model, or may correspond to a value calculated based on the output value.

Meanwhile, at least one neural network model included in the feature extraction module 1200 of the present invention may correspond to a neural network model trained in advance through training data for a classification set including a plurality of classification items. Preferably, the feature extraction module 1200 may include a plurality of neural network models.

The classification module 1300 performs inference on the encrypted text data by inputting the learning vector derived from the feature extraction module 1200. Specifically, the classification module 1300 labels a specific classification item for the encrypted text data among a plurality of classification items to be classified, by giving weight to at least one feature value included in the learning vector.

Specifically, the classification module 1300 includes at least one neural network model, uses an intermediate vector outputted by inputting the learning vector to at least one neural network model to derive a probability for each of the classification items, and labels the encrypted text data as a specific classification item having the highest probability.

Meanwhile, according to one embodiment of the present invention, the encrypted text data may be stored in the memory of the computing device 1000, and in another embodiment of the present invention, the computing device 1000 may receive the encrypted text data through a separate computing device 1000 such as a user terminal.

In addition, although not shown in FIG. 2, the computing device 1000 may include an encryption module, and the encryption module may encrypt plaintext text data into encrypted text data by using a predetermined encryption scheme.

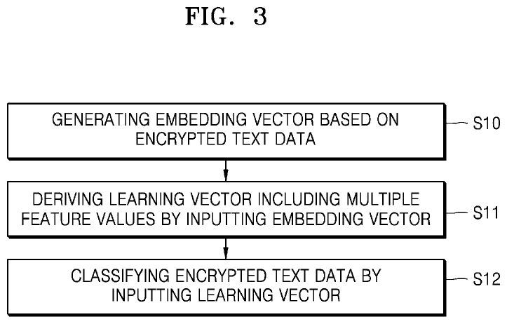

FIG. 3 schematically shows a method of classifying encryption data performed in the computing device 1000 based on the neural network according to one embodiment of the present invention.

As shown in FIG. 3, the method for classifying encryption data based on neural network and performed in a computing device 1000 including at least one processor and at least one memory may include: an embedding step S10 of digitizing encrypted text data to generate an embedding vector corresponding to the encrypted text data and having a vector form; a feature extraction step S11 of deriving a learning vector including a plurality of feature values corresponding to the embedding vector, by a feature extraction module 1200 including a plurality of trained neural network models; and a classification step S12, by a classification module 1300 including a plurality of fully connected layers, of receiving the learning vector as input to label the encrypted text data with a specific classification item among a plurality of classification items into which the encrypted text data is classified.

Specifically, in the embedding step S10 performed by the embedding module 1100, a plurality of objects included in the encrypted text data may be expressed as an embedding vector in the form of a digitized vector, and the embedding vector derived through the embedding step S10 may be expressed in the form of a matrix having a plurality of dimensions. The embedding vector may be used as an input of the above-described feature extraction step S11, and finally, the labeling may be performed on the encrypted text data corresponding to the embedding vector, through the classification step S12.

Preferably, in the embedding step S10, the encrypted text data may be processed in order to derive the embedding vector for a plurality of objects included in the encrypted text data, and the embedding vector for the objects included in the processed encrypted text data may be derived.

In the feature extraction step S11 performed by the feature extraction module 1200, the embedding vector is inputted to the neural network models included in the feature extraction module 1200, so that a learning vector including a plurality of feature values corresponding to the embedding vector is derived.

Specifically, in the feature extraction step S11, feature information including a plurality of feature values, which are derived by inputting the embedding vector to the first neural network model of the neural network models, may be inputted to the second neural network model, and the learning vector may be derived through the above process based on feature information including a plurality of feature values outputted from the last neural network model.

In the classification step S12 performed by the classification module 1300, the learning vector is inputted to a plurality of fully connected layers included in the classification module 1300, so that a specific classification item for the encrypted text data is finally labeled.

Specifically, in the classification step S12, the intermediate vector, which is derived by inputting the learning vector to the first fully connected layer of the fully connected layers, is inputted to the second fully connected layer, the probability for each of the classification items is calculated based on the intermediate vector outputted from the last fully connected layer through the above process, and a specific classification item having the highest probability is returned as a labeling value of the encrypted text data.

Accordingly, the computing device 1000 sequentially performs the embedding step S10, the feature extraction step S11 and the classification step S12 with respect to the encrypted text data, so that the classification task may be performed on the encrypted text data.

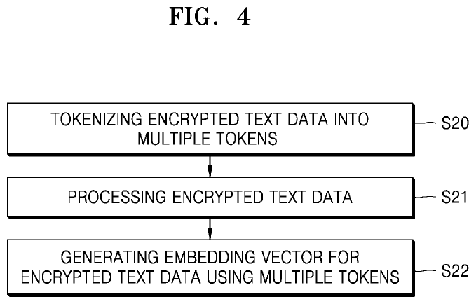

FIG. 4 schematically shows detailed steps of an embedding step S10 according to one embodiment of the present invention.

As shown in FIG. 4, the embedding step S10 may include: a token generation step S20 of generating a plurality of tokens in word units based on the encrypted text data; a data processing step S21 of processing the encrypted text data by removing special characters and spaces contained in the encrypted text data; and an encoding step S22 of generating an embedding vector for the processed encrypted text data by using the tokens.

Specifically, in the token generation step S20, the encrypted text data is set as input, and tokenization is performed by dividing the encrypted text data into tokens in a predetermined unit, specifically, in a word unit. In other words, the number of the tokens generated in the token generation step S20 may correspond to the number of types of words included in the encrypted text data.

In the data processing step S21, the encrypted text data is processed according to a predetermined rule in order to easily generate an embedding vector for the encrypted text data according to the tokens generated in the token generation step S20.

Specifically, in the data processing step S21, the encrypted text data is processed by removing special characters, spaces, punctuations, and the like included in the encrypted text data.

In the encoding step S22, an embedding vector for the processed encrypted text data is generated according to the tokens. Specifically, in the encoding step S22, the embedding vector is generated through a one-hot encoding scheme. More specifically, in the encoding step S22, each of the tokens is used as an index, and a binary vector for the processed encrypted text data is generated according to the following [Equation 1] for each index.

$${I}_{L} ( x ) := \{ \begin{matrix}1 & if x ∈ L \\ 0 & if x ∉ L\end{matrix} ( L is the number of a plurality of tokens ) \begin{matrix} \\ \end{matrix} \qquad [ Equation 1 ]$$

Accordingly, a binary vector for a specific index calculated according to Equation 1 may have a length of L.

The embedding vector finally calculated by performing the one-hot encoding scheme on each of the tokens through the encoding step S22 may be expressed as the following [Equation 2].

$$e = ( \begin{matrix}0 & … & {I}_{{j}_{1} = 1} & … & 0 \\ ⋮ & … & {I}_{{j}_{2} = 1} & … & ⋮ \\ ⋮ & … & ⋮ & … & ⋮ \\ 0 & … & {I}_{{j}_{n} = 1} & … & 0\end{matrix} ) ∈ {R}^{n \times L} ( n is the number of encrypted text data ) \qquad [ Equation 2 ]$$

The embedding vector e calculated according to Equation 2 in the above manner may be expressed as a matrix having a size of n*L.

As described above, the embedding vector is derived by the one-hot encoding scheme in the encoding step S22 according to one embodiment of the present invention. However, in another embodiment of the present invention, in the encoding step S22, any one of the conventional schemes, such as Word2Vec, may be used for embedding texts.

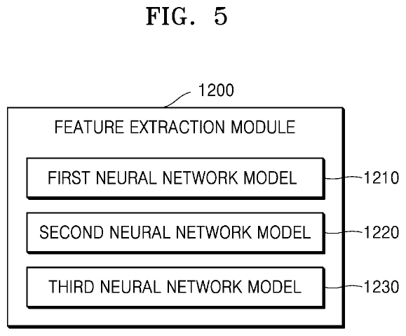

FIG. 5 schematically shows internal components of the feature extraction module 1200 according to one embodiment of the present invention.

As shown in FIG. 5, the feature extraction module 1200 includes a first neural network model 1210, a second neural network model 1220, and a third neural network model 1230, in which the first neural network model 1210 may correspond to a bidirectional LSTM (BLSTM) neural network model, the second neural network model 1220 may correspond to a gated recurrent unit (GRU) neural network model, and the third neural network model 1230 may correspond to a long-short term memory (LSTM) neural network model.

As described above, the feature extraction module 1200 may include a plurality of neural network models, and preferably, the feature extraction module 1200 may include a first neural network model 1210, a second neural network model 1220, and a third neural network model 1230.

According to the present invention, the neural network model may correspond to an artificial intelligence model including a deep neural network, and maybe trained in a deep learning manner. In addition, the neural network model may include neural networks such as convolutional neural network (CNN), recurrent neural network (RNN), gated recurrent units (GRU), and long short-term memory (LSTM), and may include various neural networks known in the related art in addition to the above-mentioned neural network.

Meanwhile, the first neural network model 1210, the second neural network model 1220, and the third neural network model 1230 may all correspond to the same type of neural network model. However, preferably, the first neural network model 1210, the second neural network model 1220, and the third neural network model 1230 may include different neural network models, respectively. Specifically, the first neural network model 1210 includes the bidirectional long short-term memory (BLSTM) neural network the second neural network model 1220 includes the GRU neural network, and the third neural network model 1230 includes the LSTM neural network.

Accordingly, the feature extraction module 1200 includes three neural network models, in which the first neural network model 1210 includes the BLSTM neural network, the second neural network model 1220 includes the GRU neural network, and the third neural network model 1230 includes the LSTM neural network, so that the classification task of the encrypted text data having characteristics, such as symmetric key encryption scheme, other than the homomorphic encryption may be effectively performed. In addition, through the above configuration, the classification task is not limited to the binary classes, and the classification task may be effectively performed for at least three multi-classes.

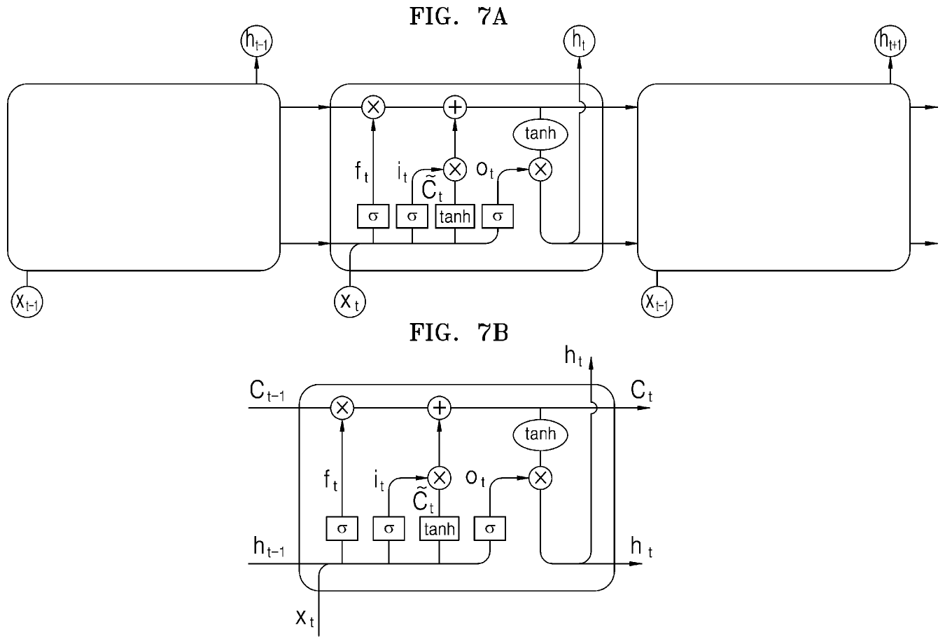

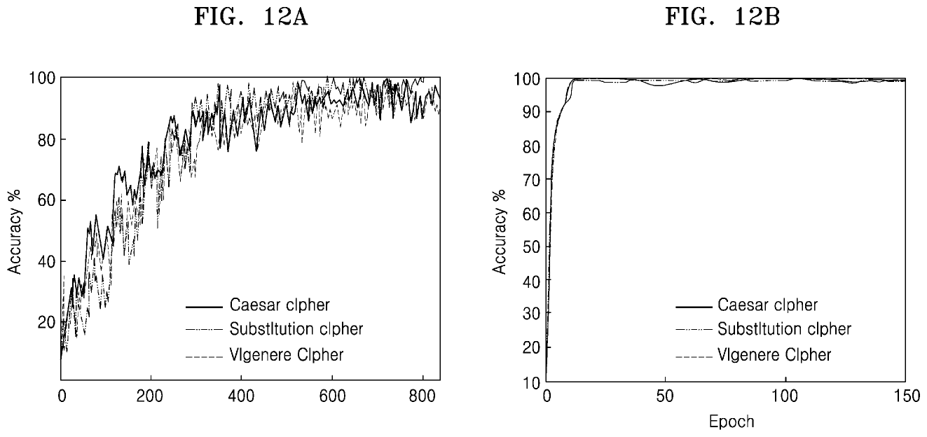

Specific configurations of the first neural network model 1210 to the third neural network model 1230 will be described in detail regarding FIGS. 7 to 9. The test results using the feature extraction module 1200 composed of the BSLTM neural network—the GRU neural network—the LSTM neural network as described above will be described in detail with reference to FIG. 12A and FIG. 12B.

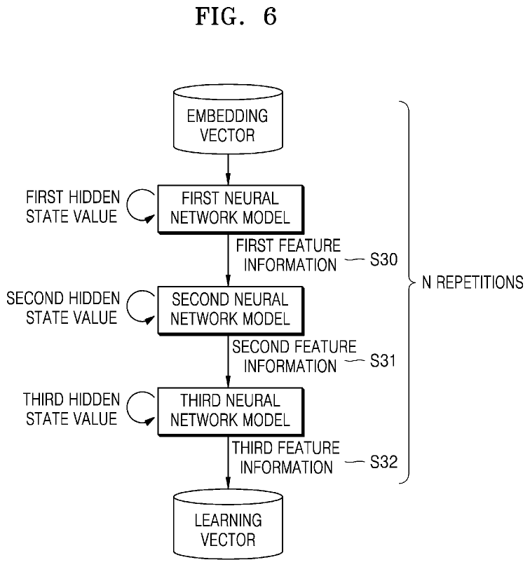

FIG. 6 schematically shows detailed steps of the feature extraction step S11 according to one embodiment of the present invention.

As shown in FIG. 6, the feature extraction module 1200 includes a first neural network model 1210, a second neural network model 1220, and a third neural network model 1230, and the feature extraction step S11 may include: a first feature information deriving step S30 of deriving first feature information by inputting the embedding vector to the first neural network model 1210; a second feature information deriving step S31 of deriving second feature information by inputting the first feature information to the second neural network model 1220; a third feature information deriving step S32 of deriving third feature information by inputting the second feature information to the third neural network model 1230; and a learning vector deriving step S33 of deriving a learning vector based on the third feature information.

Specifically, in the first feature information deriving step S30, the embedding vector derived through the embedding step S10 is inputted to the first neural network model 1210, and the first neural network model 1210 receives the embedding vector to output the first feature information. At this point, the embedding vector is inputted to the first neural network model 1210 in a time series sequence like the sequence of the encrypted text data, and the first neural network model 1210 may preferably correspond to the BLSTM neural network as described above.

Meanwhile, in the second feature information deriving step S31, the first feature information outputted in the first feature information deriving step S30 is inputted to the second neural network model 1220, and the second neural network model 1220 receives the first feature information to output the second feature information. At this point, the first feature information is inputted to the second neural network model 1220 in time series sequence, and the second neural network model 1220 may preferably correspond to the GRU neural network as described above.

In the third feature information deriving step S32, the second feature information outputted in the second feature information deriving step S31 is inputted to the third neural network model 1230, and the third neural network model 1230 receives the second feature information to output the third feature information. Likewise, the second feature information is inputted to the third neural network model 1230 in time series sequence, and the third neural network model 1230 may preferably correspond to the LSTM neural network as described above.

Finally, in the learning vector deriving step S33, the learning vector is derived based on the third feature information outputted in the third feature information deriving step S32. In the learning vector deriving step S33, the third feature information may be used as a learning vector without separately processing the third feature information, or a predetermined weight may be applied to the third feature information to derive the learning vector.

Meanwhile, the feature information outputted from each of the first neural network model 1210, the second neural network model 1220, and the third neural network model 1230 may include a plurality of feature values outputted for each node of each neural network model, and the feature value may correspond to a hidden state value in the corresponding neural network model.

According to one embodiment of the present invention, the first feature information deriving step S30, the second feature information deriving step S31, and the third feature information deriving step S32 may be performed one time. However, According to another embodiment of the present invention, in the feature extraction step S11, as shown in FIG. 6, the first feature information deriving step S30, the second feature information deriving step S31, and the third feature information deriving step S32 may be repeated N times (N is a natural number of 2 or more) until the learning vector deriving step S33 is performed, and each of the neural network models repeated M times (M is a natural number of N or less) may derive the feature information by using hidden state information derived after repeated M−1 times.

Specifically, the first feature information deriving step S30, the second feature information deriving step S31, and the third feature information deriving step S32 may be repeatedly performed N times (N is a natural number of 2 or more). In the first feature information deriving step (S30) performed M−1 times (M is a natural number less than or equal to N), the embedding vector is inputted to the first neural network model 1210, the first neural network model 1210 outputs first feature information including a plurality of feature values outputted from each node, and accordingly, the first hidden state value including a plurality of hidden state values for each node is updated. The first feature information may be inputted to the second neural network model 1220 in the second feature information deriving step S31 performed for the (M−1)^{th} time, and the first hidden state value may be used to output the first feature information in the M^{th} first feature information deriving step S30.

Meanwhile, in the second feature information deriving step S31 performed for the (M−1)th time, the first feature information outputted from the first neural network model 1210 in the first feature information deriving step S30 performed for the (M−1)th time to the second neural network model 1220, and the second neural network model 1220 derives second feature information including a plurality of feature values outputted from each node, and accordingly, updates a second hidden state value including a plurality of hidden state values for each node. The second feature information is inputted to the third neural network model 1230 in the third feature information deriving step S32 performed for the (M−1)^{th} time, and the second hidden state value may be used to output the second feature information in the M^{th} second feature information deriving step S31.

Likewise, in the third feature information deriving step S32 performed for the (M−1)th time, the second feature information outputted from the second neural network model 1220 in the second feature information deriving step S31 performed for the (M−1)th time to the third neural network model 1230, and the third neural network model 1230 outputs third feature information including a plurality of feature values outputted from each node, and accordingly, updates a third hidden state value including a plurality of hidden state values for each node. The third hidden state value updated for the (M−1)^{th} time may be used to derive the third feature information in the M^{th} third feature information deriving step S32.

Meanwhile, when the third feature information is outputted in the third feature information deriving step S32 performed for the N^{th} time, the third feature information may be used to derive a learning vector in the learning vector deriving step S33, and the third feature information outputted in the third feature information deriving step S32 performed in less than the N^{th} time is not used in the learning vector deriving step S33.

According to the present invention, as described above, the first feature information deriving step S30, the second feature information deriving step S31, and the third feature information deriving step S32 may be repeated N times, the hidden state value updated through each step performed for the (M−1)th time may be used to derive feature information through the neural network model in each step performed for the M^{th} time, and the classification task for the encrypted text data can be performed more accurately through the configuration of repeating N times.

Meanwhile, according to one embodiment of the present invention, the value of N may be preset by the user, in which the first hidden state value of the first neural network model 1210 in the first feature information deriving step S30 performed for the first time, the second hidden state value of the second neural network model 1220 in the second feature information deriving step S31 performed for the first time, and the third hidden state value of the third neural network model 1230 in the third feature information deriving step S32 performed for the first time may correspond to a value initialized to a predetermined value, and preferably, the predetermined value may be zero.

FIG. 7A and FIG. 7B schematically show a first type of neural network according to one embodiment of the present invention.

The neural network model shown in FIG. 7A is a diagram schematically showing the overall configuration of the long-short term memory (LSTM) neural network, and FIG. 7B is a diagram schematically showing one cell unit in the LSTM.

As shown in FIG. 7A, the LSTM neural network is a kind of RNN, and suitable for processing sequence data in which a value in the previous order may affect a value in the next order. As shown in FIG. 7A, the LSTM neural network includes a plurality of cell units, and the cell units are sequentially connected to each other.

Values included in the sequence data are sequentially inputted to each of the cell units sequentially connected to each other. For example, the Xₜ₋₁^{th} value included in the sequence data is inputted to the cell unit shown on the left of FIG. 7A, the Xₜ^{th} value included in the sequence data is inputted to the cell unit shown in the center, and the Xₜ₊₁^{th} value included in the sequence data is inputted to the cell unit shown on the right. The sequence data may correspond to the above-described embedding vector, the first feature information outputted from the first neural network model 1210, or the second feature information outputted from the second neural network model 1220.

Meanwhile, the cell unit additionally receives a cell state value and a hidden state value outputted from the previous cell unit. For example, the cell unit shown in the center of FIG. 7A additionally receives a cell state value Cₜ₋₁ and a hidden state value hₜ₋₁ that are outputted from the cell unit shown on the left.

Accordingly, the cell unit uses the input value of the sequence data corresponding to the cell unit, and the cell state value and the hidden state value outputted from the previous cell unit, so that the cell state value in the corresponding cell unit is outputted by determining amounts of the cell state value of the previous cell unit and the input value of the sequence data inputted to the cell unit, and a value obtained by filtering the input value of the sequence data inputted to the corresponding cell unit with the outputted cell state value is outputted as a hidden state value and an output value (feature value) of the corresponding cell unit.

Meanwhile, the cell state value and the hidden state value outputted from the corresponding cell unit are inputted to the next cell unit, each cell unit of the LSTM neural network calculates output information in its own cell unit by reflecting the output information of the previous cell unit as in the above manner, so the LSTM neural network corresponds to a neural network model suitable for processing sequence data that are related sequentially.

FIG. 7B schematically shows the detailed configuration of the cell unit of the LSTM neural network.

As shown in FIG. 7B, a refers to a sigmoid function, tanh refers to a hyperbolic tangent function, the following [Equation 3] and [Equation 4] refer to a sigmoid function and a hyperbolic tangent function, respectively, and ‘x’ and ‘+’ refer to pointwise operations of multiplication and addition.

$$σ ( x ) = \frac{1}{1 + {e}^{- x}} \qquad [ Equation 3 ]$$

$$tan h ( x ) = \frac{{e}^{x} - {e}^{- x}}{{e}^{x} + {e}^{- x}} \qquad [ Equation 4 ]$$

Meanwhile, fₜ shown in FIG. 7B corresponds to a factor that determines the degree of considering Cₜ₋₁ which is the previous cell state value, iₜ and C̅ correspond to factors for updating Cₜ which is the cell state value to be outputted, and Oₜ corresponds to a factor for calculating hₜ corresponding to the output value (feature value) and the hidden state value. The above-described factors may be expressed according to the following [Equation 5] to [Equation 10], respectively.

fₜ=σ(u_{f}xₜ+w_{f}hₜ₋₁+b_{f}) [Equation 5]

iₜ=σ(uᵢxₜ+wᵢhₜ₋₁+bᵢ) [Equation 6]

C̅ₜ= tanh (u_{c}xₜ+w_{c}hₜ₋₁+b_{c}) [Equation 7]

Cₜ=fₜ⊗cₜ₋₁+iₜ⊗C̅ₜ [Equation 8]

Oₜ=σ(uₒxₜ+wₒhₜ₋₁+bₒ) [Equation 9]

hₜ=Oₜ⊗tanhCₜ [Equation 10]

(where, u is a weight vector value for the t^{th} input value x, w is the (t−1)^{th} hidden state value, and b is a bias)

Accordingly, each cell unit in the LSTM neural network receives the cell state value Cₜ₋₁ and the hidden state value hₜ₋₁ outputted from the previous cell unit as inputs and outputs the cell state value Cₜ and the hidden state value hₜ for Xₜ inputted to the corresponding cell unit, so as to effectively derive feature values for text data in which words are formed sequentially and correlations exist between the sequentially connected words.

The above-described LSTM neural network may be included in the third neural network model 1230. In another embodiment of the present invention, the third neural network model 1230 may include LSTM neural network with additional elements added to a basic LSTM neural network structure, such as LSTM neural network in which a peephole connection is added to the cell unit of the LSTM neural network shown in FIG. 7A and FIG. 7B.

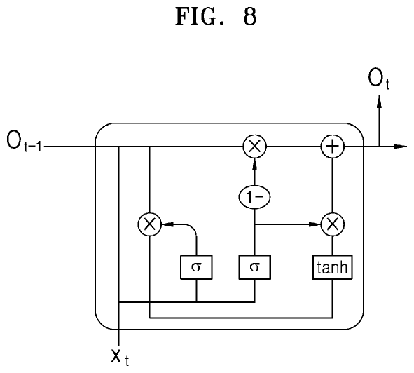

FIG. 8 schematically shows a second type of neural network according to one embodiment of the present invention.

The diagram shown in FIG. 8 is a diagram schematically showing a cell unit included in the gated recurrent unit (GRU) neural network. The GRU neural network is also a kind of RNN, and corresponds to a simplified structure of the above-described LSTM neural network.

Compared with the cell unit of the LSTM neural network including an output gate, an input gate and an erase gate, a cell unit of the GRU neural network contains only an update gate and a reset gate, in which the reset gate determines the degree of using past information received through a previous cell unit, and the update gate determines the update rate of the past information and the current information inputted to the corresponding cell unit.

Accordingly, the GRU neural network has a faster learning speed compared to the LSTM neural network because the number of parameters to be trained is smaller than that of the LSTM neural network. However, there is no significant difference in performance. The above GRU neural network may be included in the above-described second neural network model 1220.

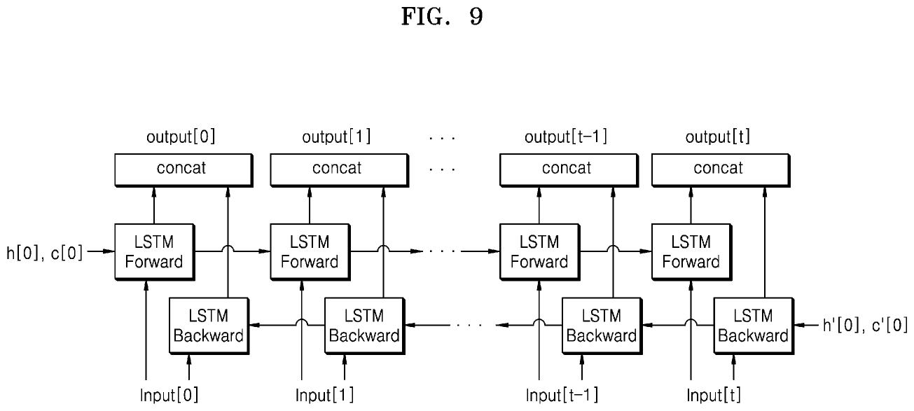

FIG. 9 schematically shows a third type of neural network according to one embodiment of the present invention.

The diagram shown in FIG. 9 is a diagram schematically showing the overall configuration of a bidirectional LSTM (BLSTM) neural network. The BLSTM neural network is also a kind of RNN, and has a structure in which the two LSTM neural networks described above are connected.

Specifically, in the first LSTM positioned at the top as shown in FIG. 9, sequence data having an order (Input[0] to Input[t] in FIG. 9) is sequentially inputted to each sequentially connected cell unit, and cell state values (c[0] to c[t−1] in FIG. 9) and hidden state values (h[0] to h[t−1] in FIG. 9) updated in the previous cell unit are inputted, so that an output value (feature value) is outputted, as described in FIG. 7. In other words, in the first LSTM, the cell state values and the hidden state values in the previous cell unit are considered according to the forward direction of the sequence data, so that a feature value of the input value of the received sequence data is derived.

Meanwhile, in the second LSTM positioned at the bottom, a plurality of cell units are connected in a sequence reverse to the above-described first LSTM, in which sequence data having an order (Input[t] to Input[0] in FIG. 9) is sequentially inputted to each cell unit, and cell state values (c′[0] to c′[t−1] in FIG. 9) and hidden state values (h′[0] to h′[t−1] in FIG. 9) updated in the precedent cell unit are inputted, so that an output value (feature value) is outputted. In other words, in the second LSTM, the cell state values and the hidden state values in the precedent cell unit are considered according to the reverse direction of the sequence data, so that a feature value of the input value of the received sequence data is derived.

Meanwhile, the BLSTM neural network considers the feature values outputted from each cell unit receiving the input value of the same sequence data in the first LSTM and the second LSTM, so that final feature values (output[0] to output[t] in FIG. 9) are derived. For example, the final feature value may be derived simply by combining the feature value outputted from the first SLTM cell unit and the feature value outputted from the second LSTM cell unit, or the final feature value may be derived by applying a predetermined weight to each of the feature value outputted from the first LSTM cell unit and the feature value outputted from the second LSTM cell unit.

Accordingly, whereas the LSTM neural network shown in FIG. 7A and FIG. 7B has a structure that learns in the forward direction of the sequence data, the BLSTM neural network shown in FIG. 9 has a structure that learns while considering both of the forward and reverse directions of the sequence data, and the BLSTM neural network may be included in the above-described first neural network model 1210.

Meanwhile, the number of cell units included in each neural network model in FIGS. 7A and 7B to 9 may correspond to the number of input values of the inputted sequence data. For example, when the sequence data is text data and the text data contains 10 words, each neural network model may contain 10 cell units.

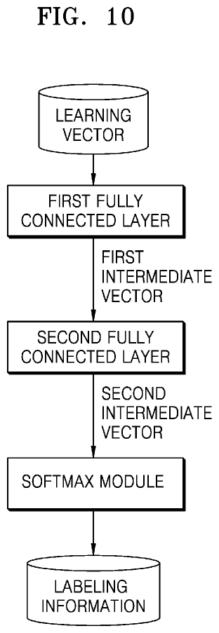

FIG. 10 schematically shows detailed steps of the classification step S12 according to one embodiment of the present invention.

As shown in FIG. 10, the classification step S12 may include: deriving an intermediate vector having a size corresponding to the number of a plurality of classification items into which the encrypted text data is classified, by inputting the learning vector to the fully connected layers; and labeling the encrypted text data as a specific classification item among the classification items, by applying a Softmax function to values included in the intermediate vector.

Specifically, in the classification step S12, a learning vector including a plurality of feature values with respect to the encrypted text data through the feature extraction step S11 is inputted to a plurality of fully connected layers so as to derive an intermediate vector corresponding to the learning vector, and the intermediate vector is inputted to a Softmax module so as to derive a probability value for each of a plurality of classification items capable of classifying the encrypted text data, and label a classification item having the highest probability value on the encrypted text data.

More specifically, in the classification step S12, the learning vector is inputted to the first fully connected layer. The first fully connected layer applies a learned weight to each of the feature values included in the received learning vector, so that a first intermediate vector is derived.

Meanwhile, the first intermediate vector is inputted to a second fully connected layer, and the second fully connected layer applies a learned weight to each of the values included in the received first intermediate vector, so that a second intermediate vector is derived. Preferably, the number of values included in the second intermediate vector is the same as the number of a plurality of classification items capable of classifying the encrypted text data.

Finally, the second intermediate vector is inputted to the Softmax module, and the Softmax module applies a Softmax function to the second intermediate vector, thereby calculating a probability value for each of the classification items that can be classified. Meanwhile, a value obtained by adding up all probability values for the classification items may be 1.

Accordingly, when the probability values of the classification items are calculated through the Softmax module, the classification task may be completed on the encrypted text data in the classification step S12 by classifying (labeling) the encrypted text data into a classification item having the highest probability value.

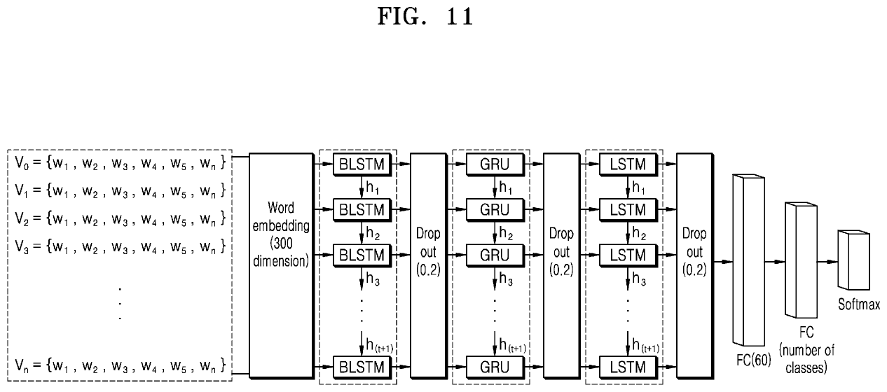

FIG. 11 schematically shows a conceptual diagram of the method for classifying encrypted data based on neural network according to one embodiment of the present invention.

As shown in FIG. 11, in the embedding step S10, the encrypted text data (V0 to Vn in FIG. 11) is received to derive an embedding vector including a plurality of vector values, so that the encrypted text data may be processed in the feature extraction step S11 and the classification step S12.

In the feature extraction step S11, the embedding vector is inputted to the feature extraction module 1200 including a plurality of neural network models, preferably including a first neural network model 1210, a second neural network model 1220, and a third neural network model 1230, the first neural network model 1210 including the BLSTM neural network receives the embedding vector to derive first characteristic information, the second neural network model 1220 including the GRU neural network receives the first feature information to derive second feature information, and the third neural network model 1230 including the LSTM neural network receives the second feature information to derive third feature information. In the feature extraction step S11, the learning vector is finally derived based on the third feature information.

Meanwhile, each of the first neural network model 1210, the second neural network model 1220, and the third neural network model 1230 may drop out several cell units in order to derive the feature information.

In the classification step S12, the intermediate vector is derived by inputting the learning vector to the fully connected layers, the probability values for the classification items capable of classifying the encrypted text data by applying the Softmax function to a plurality of values included in the intermediate vector, so that the encrypted text data is labeled with the classification item having the highest probability value.

Meanwhile, the fully connected layers are composed of two layers as shown in FIG. 11, in which the first fully connected layer receives the learning vector as input to derive a first intermediate vector including a predetermined number (60) of values, and the second fully connected layer receives the first intermediate vector as input to derive a second intermediate vector having a size corresponding to the number of the classification items.

In the present invention, the first neural network model 1210, the second neural network model 1220, and the third neural network model 1230 may include various conventional models such as CNN, LSTM and GRU, however, as described above, the high classification accuracy is indicated for the encrypted text data as shown in FIG. 12A and FIG. 12B when the first neural network model 1210 includes the BLSTM neural network, the second neural network model 1220 includes the GRU neural network, and the third neural network model 1230 includes the LSTM neural network.

FIG. 12A and FIG. 12B schematically show classification results according to the method of classifying encrypted data based on the neural network according to one embodiment of the present invention.

As described above, FIG. 12A and FIG. 12B schematically show test results of the classification task on the encrypted text data, when the first neural network model 1210 is BLSTM, the second neural network model 1220 is GRU, and the third neural network model 1230 is LSTM. A cross-entropy loss function was used in the above test. The cross-entropy loss function is expressed as [Equation 11], and corresponds to a function that estimates parameter values such that the neural network model is trained to be closer to the correct answer by calculating a deviation between a value previously labeled on the input data and a value labeled on the input data in the neural network model of the present invention.

loss=−Σₖ₌₁^{K}tₖ log yₖ [Equation 11]

In regard to the loss of the cross-entropy loss function in Equation 11, k corresponds to an index number for the number of input data, t corresponds to a correct answer labeling value for the encrypted text data, and y corresponds to an output labeling value of the neural network model.

Meanwhile, as shown in [Table 1], ‘Company Report Dataset’ and ‘Brown Dataset’ corresponding to data sets, which are opened as the input data, were used in order to perform the test. The ‘Company Report Dataset’ has a relatively short sentence length, and the total number of sentences is 480. The ‘Brown Dataset’ has a relatively long sentence length, and the total number of sentences is 57,340. The ratio of training data and test data was set to 8:2 in the both datasets.

TABLE 1

| | Total data | | | |
|---|---|---|---|---|
| Name | (sentence) | Training data | Test data | Categories |
| Brown corpus | 57,340 | 80% | 20% | 15 |
| Company report | 480 | 80% | 20% | 4 |

FIG. 12A shows the accuracy results on ‘Brown Dataset’, and FIG. 12B shows the accuracy results on ‘Company Report Dataset’. Meanwhile, Caesar encryption, Vigenere encryption, and Substitution encryption schemes, which have chaos properties as encryption properties that make the contents of plaintext difficult to guess, were used in order to perform encryption for each dataset. Meanwhile, the neural network model was not given any prior information about a character frequency or encryption key for the encrypted text data.

As shown in FIG. 12A and FIG. 12B, as a result of encrypting each test dataset and classifying the encrypted data, it can be seen that the classification task is performed on the encrypted text data with very high accuracy when the number of learning (epoch) significantly increases. In other words, through the hybrid neural network model composed of BLSTM-GRU-LSTM proposed in the present invention, the encrypted text data can be classified with high accuracy regardless of the length and type of encrypted text data.

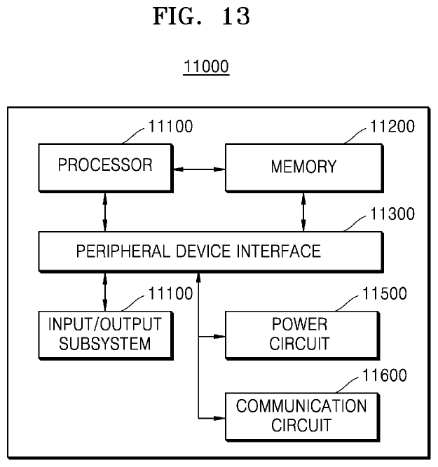

FIG. 13 schematically shows internal components of the computing device according to one embodiment of the present invention.

The above-described computing device 1000 shown in FIG. 1 may include components of the computing device 11000 shown in FIG. 13.

As shown in FIG. 13, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 executes the software module or the instruction set stored in memory 11200, thereby performing various functions for the computing device 11000 and processing data.

The I/O subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may also be combined to the peripheral interface 11300 without passing through the I/O subsystem.

The power circuit 11500 may provide power to all or a portion of the components of the terminal. For example, the power circuit 11500 may include a power management system, at least one power source charging system for a battery or alternating current (AC), a power failure detection circuit, a power converter or inverter, a power status indicator, or any other components for generating, managing, and distributing the power.

The communication circuit 11600 uses at least one external port, thereby enabling communication with other computing devices.

Alternatively, as described above, the communication circuit 11600 may include an RF circuit, if needed, to transmit and receive an RF signal, also known as an electromagnetic signal, thereby enabling communication with other computing devices.

The embodiment of FIG. 13 is merely an example of the computing device 11000, and the computing device 11000 may have a configuration or arrangement in which some components shown in FIG. 13 may be omitted, additional components not shown in FIG. 28 may be further provided, or at least two components may be combined. For example, a computing device for a communication terminal in a mobile environment may further include a touch screen, a sensor or the like in addition to the components shown in FIG. 13. The communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, so as to be recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments, may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, in regard to the processing device, some cases may have described that one processing device is used, however, it will be appreciated by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. Software and data may be stored in at least one computer-readable recording media.

The method according to the embodiment may be implemented in the form of program instructions to be executed through various computing mechanisms, so as to be recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like, as well as a machine code generated by a compiler. The above hardware device may be configured to operate as at least one software module to perform the operations of the embodiments, and vise versa.

According to one embodiment of the present invention, data classification can be performed on the encrypted text data itself without decrypting the encrypted text data obtained by encrypting the plaintext text data.

According to one embodiment of the present invention, the data classification can be performed on symmetric key encryption currently used as encryption scheme for data confidentiality in general, in addition to text data encrypted by homomorphic encryption.

According to one embodiment of the present invention, a hybrid neural network containing a plurality of neural network models is used, so that the accuracy of classifying the encrypted text data can be improved.

According to one embodiment of the present invention, data classification can be performed for at least 3 classes, in addition to data classification for binary class issue.

Although the above embodiments have been described with reference to the limited embodiments and drawings, however, it will be understood by those skilled in the art that various changes and modifications may be made from the above-mentioned description For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for classifying encrypted data based on neural network performed on a computing device including at least one processor and at least one memory, the method comprising:
an embedding step of digitizing encrypted text data to generate an embedding vector corresponding to the encrypted text data and having a vector form;
a feature extraction step of deriving a learning vector including a plurality of feature values corresponding to the embedding vector, by a feature extraction module including a plurality of trained neural network models; and
a classification step, by a classification module including a plurality of fully connected layers, of receiving the learning vector as input to label the encrypted text data with a specific classification item among a plurality of classification items into which the encrypted text data is classified.

2. The method of claim 1, wherein the encrypted text data corresponds to text data encrypted using a symmetric key encryption.

3. The method of claim 1, wherein the embedding step include:
a token generation step of generating a plurality of tokens in word units based on the encrypted text data; a data processing step of processing the encrypted text data by removing special characters and spaces contained in the encrypted text data; and
an encoding step of generating an embedding vector for the processed encrypted text data by using the tokens.

4. The method of claim 1, wherein the feature extraction module includes a first neural network model, a second neural network model, and a third neural network model, and the feature extraction step includes:
a first feature information deriving step of deriving first feature information by inputting the embedding vector to the first neural network model;
a second feature information deriving step of deriving second feature information by inputting the first feature information to the second neural network model;
a third feature information deriving step of deriving third feature information by inputting the second feature information to the third neural network model; and
a learning vector deriving step of deriving a learning vector based on the third feature information.

5. The method of claim 4, wherein, in the feature extraction step, the first feature information deriving step, the second feature information deriving step and the third feature information deriving step are repeated N times (N is a natural number of 2 or more) until the learning vector deriving step is performed, and each of the neural network models repeated M times (M is a natural number of N or less) derives the feature information by using hidden state information derived after repeated M−1 times.

6. The method of claim 1, wherein the feature extraction module includes a first neural network model, a second neural network model, and a third neural network model, in which the first neural network model corresponds to a bidirectional LSTM (BLSTM) neural network model, the second neural network model corresponds to a gated recurrent unit (GRU) neural network model, and the third neural network model corresponds to a long-short term memory (LSTM) neural network model.

7. The method of claim 1, wherein the classification step includes:
deriving an intermediate vector having a size corresponding to the number of a plurality of classification items into which the encrypted text data is classified, by inputting the learning vector to the fully connected layers; and
labeling the encrypted text data as a specific classification item among the classification items, by applying a Softmax function to values included in the intermediate vector.

8. A computing device including at least one processor and at least one memory to perform a method for classifying encrypted data based on neural network, the computing device performing:
an embedding step of digitizing encrypted text data to generate an embedding vector corresponding to the encrypted text data and having a vector form;
a feature extraction step of deriving a learning vector including a plurality of feature values corresponding to the embedding vector, by a feature extraction module including a plurality of trained neural network models; and
a classification step, by a classification module including a plurality of fully connected layers, of receiving the learning vector as input to label the encrypted text data with a specific classification item among a plurality of classification items into which the encrypted text data is classified.
